(19) United States
(12) Patent Application Publication
(10) Pub. No.: US 2007/0273763 A1
(43) Pub. Date: Nov. 29, 2007

(54) Security camera in dispenser

(75) Inventor: Mathias Smith, Albion, IN (US)

Correspondence Address: BAKER & DANIELS LLP;111 E. WAYNE STREET, SUITE 800, FORT WAYNE, IN, 46802, US

(73) Assignee: TOKHEIM HOLDINGS, B.V., Ad Bladel (NL)

(21) Appl. No.: 11/710,636

(22) Filed: Feb. 23, 2007

Related U.S. Application Data
(63) Continuation of application No. 09/991,333, filed on Nov. 14, 2001.
(60) Provisional application No. 60/314,710, filed on Aug. 24, 2001.

(51) Int. Cl. H04N 7/00

(52) U.S. Cl. 348/143

(57) ABSTRACT

A fuel dispenser includes a surveillance system having a video camera-recorder combination such as a camcorder. The camcorder is configured to collect and record images relating to the refueling customer and/or customer vehicle. The point-of-sale (POS) terminal directs activation of the recording operation following authorization of a transaction in which the customer has selected a post-fueling payment option. If the customer leaves without paying, this drive-off event is recorded by generating a video-based delinquency report that includes a video segment corresponding to the video images recorded by the camcorder during the current transaction session. The recorded images and/or delinquency report may be furnished to a remote facility such as an Internet resource by configuring the refueling environment for connection to a communications network.

### CROSS-REFERENCE TO RELATED APPLICATIONS

This application is related to U.S. Patent Application Ser. No. 60/314,710 entitled “FUEL DISPENSER USING IDENTIFICATION DATA TO PROVIDE SECURITY AND DRIVE-OFF DETERRENCE” filed Aug. 24, 2001 and assigned to the same assignee as the present application, which is incorporated herein by reference thereto.

### BACKGROUND OF THE INVENTION

1. Field of the Invention

The present invention relates to a refueling environment, and, more particularly, to a fuel dispenser having a video camera-recorder combination configured to obtain images of the dispenser customer and/or customer vehicle, thereby providing the dispenser operator with a security measure that addresses non-payment drive-off events by facilitating positive identification of an offending customer who elects to make a post-refueling payment yet leaves without paying.

2. Description of the Related Art

The refueling industry has incorporated various technological innovations into the architecture of fuel dispensers to make them more flexible in terms of improving the customer refueling experience. For example, fuel dispenser positions typically include an automated payment terminal having a touchscreen or keypad user interface that allow the customer to make various refueling parameter selections. Among the selections a customer can make are the type and/or grade of fuel, amount of fuel, and form of payment.

Conventional dispensers include a menu-type selection feature that enables the customer to select among various forms of payment options, such as a credit card payment, cash payment, and account debiting payment. A typical user interface would include a matrix of individual depressible keys or buttons each associated with a corresponding payment function.

For example, keys of this type may include descriptors such as “Pay Credit Outside”, “Pay Credit Inside”, “Pay Debit Outside”, “Pay Debit Inside”, “Pay Cash Inside”, or the like. The inside/outside designations respectively refer to a point-of-sale (POS) terminal facility (such as a convenience store co-located with the dispenser positions) and the immediate fuel dispenser position in use by the customer.

The use of credit card machines at dispenser locations facilitates an automated payment procedure that obviates any intervention or involvement from a human operator insofar as it concerns handling of the transaction payment. This payment technology makes it possible to develop a fully automated refueling site having no resident operator. However, these automated sites have diminished service potential since they are incapable of handling cash-based transactions.

Despite this aspect of fully automated sites, refueling architectures of this type provide significant advantages in terms of establishing a secure and reliable payment facility. For example, transaction requests are not authorized until the dispenser controller receives verification that the customer payment method is valid, thereby guaranteeing the payment.

In one typical scenario, a credit card authorization check would first be performed to determine if a valid credit card account exists and if sufficient funds are available for the transaction. The account furnished by the customer is immediately billed upon completion of the transaction. In this manner, the service station operator is guaranteed payment for all rendered transactions that require such pre-payment.

For those refueling locations that do support a cash payment option, the requested transaction is authorized and can proceed only after the customer has made an up-front advance payment. For example, one typical protocol would involve the customer selecting the pay cash inside option by actuating the appropriate payment key, entering the associated convenience store to make payment, and returning to the dispenser position to commence refueling. The POS terminal operator would activate the designated dispenser position following payment by the customer.

One problem with such a payment scenario is that the customer must pre-pay an exact monetary sum, often times without knowing exactly how much fuel this sum represents. In this manner, a customer could underestimate the correct amount to be purchased, requiring the customer to make an additional payment and perform another refueling operation. Conversely, a customer could overestimate the amount of fuel to be purchased, which would necessitate seeking a refund of the unused pre-purchased amount. This pre-payment protocol therefore cannot offer the same “open-account”-type flexibility that a credit card payment system can make available.

Some cash payment protocols allow a customer to make payment following completion of the refueling operation. However, this situation makes the site operator vulnerable to theft and fraudulent use of the dispenser because a customer who is otherwise unknown to the operator can simply leave without making payment. These drive-off events have been increasing steadily in recent times as gasoline prices have risen dramatically.

The site operator typically is left with no alternative other than to designate the costs of such drive-off events as immediate losses (e.g., a non-receivable account or default payment) since current refueling configurations have no way of identifying the offending customers and pursuing them through appropriate legal proceedings to recoup the non-payments. Additionally, law enforcement is not provided with any means to precisely identify the violators and apprehend the drive-off customers.

What is therefore-needed is a fuel dispenser configuration that continues to provide the customer with an inside cash payment option, while reassuring the site operator that the framework for such a configuration will exhibit a level of security against drive-offs that is comparable to that realized with pre-payment configurations.

What is also needed is a dispenser-based security system that strikes the proper balance between protecting the pecuniary interests of the dispenser operator while safeguarding the privacy interests of the customer. The security system should be as inconspicuous as possible and should not be burdensome or intrusive to the customer. In particular, the security system should adopt a non-invasive type of surveillance that is unnoticed by the customer and does not require the direct or active involvement of the customer.

### SUMMARY OF THE INVENTION

According to the present invention there is provided a refueling environment including a plurality of refueling sites each having a plurality of fuel dispenser positions.

In one exemplary form, at least one fuel dispenser position includes a surveillance system having a video camera-recorder combination such as a camcorder. The camcorder is configured to collect and record images pertaining to the refueling customer and/or customer vehicle.

During operation, a refueling customer makes a payment selection indicating an intent to pay following completion of the refueling operation. For example, the customer may depress the payment option key marked “Pay Cash Inside” or the like. This selection is forwarded to a service request management device for processing the request. In one form, the point-of-sale (POS) terminal is equipped to handle the refueling request.

The POS terminal receives the request and authorizes the transaction. The POS terminal then directs the fuel dispenser position to activate the dispenser equipment so that refueling can proceed.

Furthermore, following approval of the transaction, the POS terminal directs the camcorder to begin recording for a duration sufficient to acquire images of the customer and/or vehicle. The camcorder otherwise is inactive.

The POS terminal monitors the transaction session to determine if a non-payment drive-off event occurs. The detected occurrence of such a drive-off event may be automatically triggered by the expiration of a transaction time period. For example, the POS terminal may set a timer once the transaction has been authorized that gives the customer a certain selectable time period (e.g., 10 minutes) to complete the refueling operation and make payment.

If the timer expires before payment is received, an alarm condition is set that indicates the occurrence of a drive-off event. Alternately, the POS terminal operator may manually set the alarm condition based upon visual indications that the customer has left without paying.

Once a drive-off event occurs and has been detected, the POS terminal compiles a record of the event. In particular, a record is generated that includes the recorded video segment pertaining to the current transaction session. For this purpose, the POS terminal directs the camcorder to download the video portion that was just recorded. The operator may annotate the record with comments such as vehicle or customer descriptions and details of transaction, such as transaction amount (fuel and cost), date, time, and location (e.g., service site identifier).

The record compiled by the POS terminal can then be forwarded to the appropriate law enforcement agency for purposes of apprehension and prosecution.

According to another form of the invention, the refueling environment is enabled for network communications so that the video-based drive-off record can be forwarded to a remote facility, such as a remote Internet server on the World Wide Web. For this purpose, the video camera-recorder combination may be provided in the form of a so-called “web-cam” device having a camcorder adapted for network communications, e.g., the Internet Web. The standard camcorder is adapted with suitable communication ports and communication circuitry to enable transmission of the recorded images over a network connection. Alternately, the camcorder may be coupled to a processor that processes the video images and performs the required signal processing operations needed to prepare the video images for transmission over the network. In one form, the network includes a packet-based data network.

The invention, in one form thereof, is directed to a system including a fuel dispenser position and a video camera-recorder combination operatively associated with the fuel dispenser position. The video camera-recorder combination is configured to acquire and record at least one video signal comprising at least one of a dispenser user image and a user vehicle image. In one form, the video camera-recorder combination is housed within a fuel dispenser terminal at the fuel dispenser position.

In one form, the video camera-recorder combination is configured further to operate in response to a signal indicating authorization of a transaction pertaining to the dispenser user. Alternately, the video camera-recorder combination is configured to operate automatically in response to a signal indicating the Presence of a vehicle in association with the fuel dispenser position.

In one form, the video camera-recorder combination includes a camcorder. Additionally, a network connection is operatively coupled to the video camera-recorder combination. This network connection is configured for connection to at least one of the Internet and World Wide Web.

The video camera-recorder combination is also configured to record over any previously recorded video portions in the absence of a signal indicative of a drive-off event pertaining to the previously recorded video portions.

The video camera-recorder combination is configured further to provide a still image, a series of images, a moving image, a full-motion video sequence, or a combination thereof.

The system, in one form thereof, further includes a means, which is responsive to a signal indicative of the occurrence of a non-payment drive-off event, for providing a record of the drive-off event occurrence using at least one video signal operatively recorded by the video camera-recorder combination.

The invention, in another form thereof, is directed to a system for use in a refueling environment having a fuel dispenser position. The system includes, in combination, a surveillance camera operatively associated with the fuel dispenser position, and a controller operatively associated with the surveillance camera. The surveillance camera is configured to collect at least one image pertaining to the fuel dispenser position. The controller is configured to direct operation of the surveillance camera in response to a signal indicative of a trigger event.

In one form, the surveillance camera is configured specifically to collect at least one image comprising at least one of a dispenser user image and a user vehicle image.

In one form, the trigger event relates to authorization of a transaction pertaining to a dispenser user, such as by a point-of-sale (POS) facility.

The system further includes a recordation apparatus configured to record images provided by the surveillance camera. The system also includes a means, which is responsive to a signal indicative of the occurrence of a non-payment drive-off event, for providing a record of the drive-off event occurrence using at least one image recorded by the recordation apparatus.

In one form, the surveillance camera and recordation apparatus together form a camcorder unit.

The system, in one form thereof, further includes a remote facility disposed apart from the refueling environment. A communications link is provided between the refueling environment and the remote facility. A means is provided to cause recorded images from the recordation apparatus to be operatively communicated to the remote facility over the communications link.

The system, in another form thereof, includes a remote facility disposed apart from the refueling environment. A communications link is provided between the refueling environment and the remote facility. A means is provided to cause collected images from the surveillance camera to be operatively communicated to the remote facility over the communications link.

The invention, in another form thereof, is directed to a system for use in a refueling environment having a fuel dispenser position. The system includes, in combination, a first means for collecting at least one image relating to the fuel dispenser position, a second means for recording images collected by the first means, and a third means for controlling operation of the first means and/or the second means. The third means activates the first means in response to a signal indicative of a trigger a event. The first means collects at least one image relating to a dispenser user and/or a user vehicle.

In one form, the trigger event relates to authorization of a transaction pertaining to a dispenser user. The trigger event signal may issue from a point-of-sale (POS) facility in the refueling environment.

In one form, the first means and second means together define a video camera-recorder combination.

The system further includes a fourth means, which is responsive to a signal indicative of the occurrence of a non-payment drive-off event, for providing a record of the drive-off event occurrence using at least one image recorded by the second means.

The system further includes a network and a fifth means for causing recorded images from the second means to be placed onto the network. The network, in one form thereof, includes the Internet and/or the World Wide Web.

The invention, in another form thereof, is directed to an apparatus for use in a refueling environment having a fuel dispenser position. The apparatus includes, in combination, a surveillance system including a video camera and a video recording device, and a controller to control the surveillance system. The video camera is disposed proximate the fuel dispenser position, while the video recording device is operatively coupled to the video camera.

The controller is configured to activate the surveillance system in response to a signal indicating approval of a transaction pertaining to a dispenser user. The video camera is configured to collect at least one image relating to a dispenser user and/or a user vehicle.

The apparatus further includes a detector to detect occurrence of a non-payment drive-off event. A recordation facility is configured to generate a record using recorded images from the video recording device, in response to a signal from the detector indicative of a detected drive-off event.

The apparatus further includes a remote facility disposed apart from the refueling environment, and a communications link between the surveillance system and the remote facility.

The invention, in another form thereof, is directed to a method for use in a refueling environment having a fuel dispenser position. According to the method, at least one image associated with the fuel dispenser position is acquired and recorded. The image acquisition follows the occurrence of a trigger event. The trigger event corresponds to authorization of a transaction pertaining to a dispenser user. In one form, the image acquisition process involves acquiring at least one image relating to a dispenser user and/or a user vehicle.

A determination is made regarding whether a non-payment drive-off event has occurred in relation to a dispenser user. In response to a determination of the drive-off event occurrence, the recorded images are associated with the drive-off event occurrence.

In one form, the recorded images are communicated to and over a network, such as the Internet and/or World Wide Web.

In one form, the image acquisition process involves providing a video camera and controlling operation of the video camera, in response to a signal issuing from a point-of-sale (POS) facility in the refueling environment indicating approval of a transaction pertaining to a dispenser user.

The invention, in another form thereof, is directed to a method for use in a refueling environment having a fuel dispenser position. According to the method, there is provided a video camera which is configured to enable the collection of at least one image associated with the fuel dispenser position. The video camera is operated in response to the occurrence of a trigger event. In one form, the trigger event corresponds to authorization of a transaction pertaining to a dispenser user.

In one form, the method also involves recording images collected by the video camera.

A determination is made regarding whether a non-payment drive-off event has occurred. Following a determination of the occurrence of a non-payment drive-off event, there is provided a record of the drive-off event occurrence using at least one recorded image.

The video camera is specifically configured to enable the collection of at least one image relating to a dispenser user and/or a user vehicle.

The invention, in another form thereof, is directed to a method for use in a refueling environment having a fuel dispenser position. The method involves the collection of at least one image relating to a dispenser user and/or a user vehicle. The image collection process follows approval of a transaction pertaining to the dispenser user. The collected images are then recorded.

A determination is made regarding whether a non-payment drive-off event has occurred in relation to the dispenser user. In response to a determination of the drive-off event occurrence, the recorded images are associated with the drive-off event occurrence. In particular, the association process involves providing a record of the drive-off event occurrence using the recorded images.

In one form, the recorded images are communicated to and over a network, such as a packet-based data network.

In another form, the image collection process involves providing a video camera and controlling the operation of the video camera, in response to a signal issuing from a point-of-sale (POS) facility in the refueling environment representing the dispenser user transaction approval.

One advantage of the present invention is that the image information collected by the surveillance system enables fuel dispenser locations to possess a level of anti-theft security similar to that which can be realized with pre-pay transaction protocols.

Another advantage of the present invention is that the collection of image information pertaining to the customer and/or customer vehicle serves as a significant deterrent to the occurrence of non-payment drive-off events, to the extent that such surveillance is known or otherwise apparent to the customer.

Another advantage of the present invention is that the compilation of a drive-off video record including a positive description of the customer and/or customer vehicle provides law enforcement authorities with a reliable evidentiary tool and an irrefutable means of identification which facilitate the apprehension and prosecution of refueling customers who commit theft.

A further advantage of the invention is that the surveillance system maintains a video record revealing the identity of the customer only under circumstances where a non-payment drive-off event has occurred, thereby allaying any concerns regarding the protection of consumer privacy interests and the unauthorized use of the video-based identification record for reasons unrelated to law enforcement (e.g., profiling).

A further advantage of the invention is that the surveillance system can be integrated into a network environment such as the Internet, thereby allowing the recorded video images (and drive-off video records) to be uploaded to a remote facility such as a network resource (e.g., server) for archival and subsequent retrieval.

A further advantage of the invention is that compilation of a video-based record following the occurrence of a drive-off event can be implemented on-site at the refueling location by the POS terminal, for example, or at a remote facility that is networked to the refueling environment.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a block diagram schematic view illustrating a surveillance system incorporated into a refueling environment, according to one example of the present invention;

FIG. 2 is a schematic pictorial view illustrating the video-based surveillance activity undertaken by the surveillance system of FIG. 1;

FIG. 3 is a schematic view depicting the functional relationship between illustrative interface circuits interconnecting the surveillance system of FIG. 1 with a controller;

FIG. 4 is a flowchart illustrating a typical operating sequence for controlling the surveillance system of FIG. 1 following a transaction authorization;

FIG. 5 is a flowchart illustrating a typical operating sequence for detecting and recording a drive-off event using the system of FIG. 1;

FIG. 6 is a flowchart illustrating a typical operating sequence for controlling the surveillance system of FIG. 1 following a transaction payment;

FIG. 7 is a block diagram schematic view illustrating a surveillance system incorporated into a refueling environment, according to another example of the present invention;

FIG. 8 is a flowchart illustrating a typical operating sequence for controlling the surveillance system of FIG. 7 following a transaction authorization; and

FIG. 9 is a flowchart illustrating a typical operating sequence for detecting and recording a drive-off event using the system of FIG. 7.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

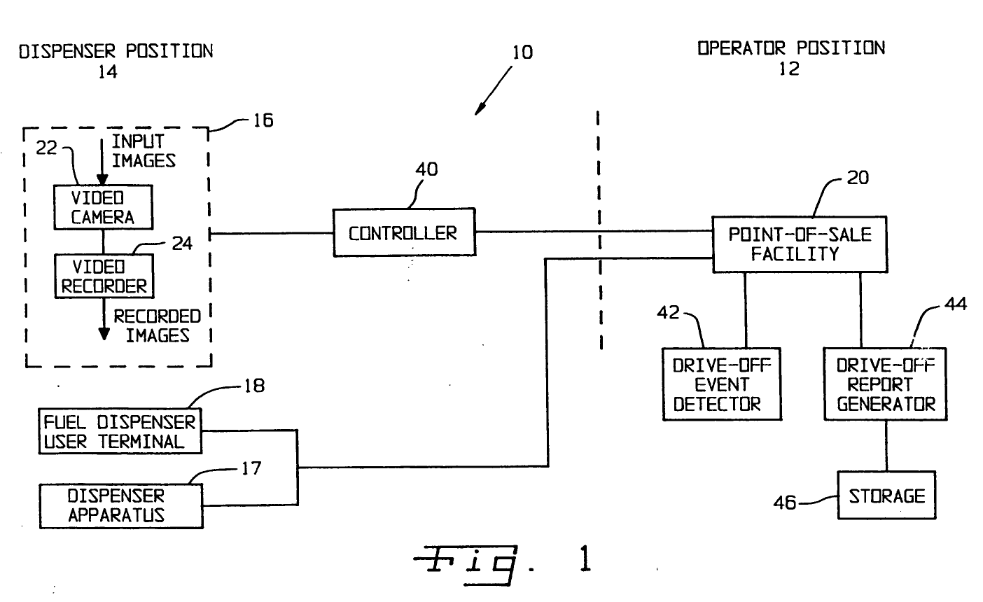

Referring now to the drawings and particularly to FIG. 1, there is shown a block diagram illustration of a refueling environment 10 including an operator position 12 and a representative dispenser position 14 configured with a surveillance system 16, according to one example of the present invention.

By way of overview, the invention according to the example of FIG. 1 generally involves the acquisition of identification (ID) information pertaining to a refueling customer and/or a customer vehicle. In particular, the ID information comprises video images of the customer who is requesting a dispenser transaction and/or the vehicle that is positioned for refueling.

In one embodiment, the image collection process takes place when the customer selects a, post-payment option, namely, when the customer indicates that payment will be tendered following completion of the refueling operation. For example, such a scenario would arise when the customer opts to make a cash payment, e.g., a “Pay Cash Inside” option.

The illustrated fuel dispenser 14 may be provided in any conventional form or standard configuration, and is generally representative of the equipment installed at a customer refueling location. One typical construction would include, for example, a fuel delivery apparatus 17 having a hose and nozzle assembly, a Controller to control the dispensing operation, a controllable fuel pump, and a vapor recovery system.

The dispenser position 14 also typically includes a user interface module or terminal 18. The user terminal 18 may include a payment module enabling the customer to customarily choose the refueling parameters (e.g., amount and type of fuel), the form of payment (e.g., cash, credit or debit), and the payment location (e.g., inside at the convenience store operator terminal or outside at the immediate dispenser position).

The illustrated operator position 12 broadly functions to manage and otherwise handle various operations relating to monitoring, authorizing, and processing a refueling transaction requested by a customer in connection with fuel dispenser 14. In one form, operator position 12 may be implemented in the form of a conventional point-of-sale (POS) facility 20 configured to perform various transaction management tasks.

For example, POS 20 may verify that the customer is authorized to receive the requested refueling services, based upon an authorization process involving the credit card number furnished by the customer. The activities and tasks of POS 20 can be executed automatically, namely, without the intervention of an operator or other manual input or direction. Alternately, POS 20 may be manned by a station operator.

Moreover, the functionality of POS 20 may be provided in a centralized or distributed platform. For example, a conventional POS terminal can be used to perform the traditional functions associated with managing the transaction session, while a dedicated controller can be used to control the functionality of surveillance system 16. Alternately, the control function can be embodied within the standard POS terminal using suitable integration tools.

As known, POS 20 can be provided in any of various suitable forms. For example, POS 20 may be configured with any combination of hardware, software, or firmware. Additionally, POS 20 will preferably have a programmable feature enabling it to receive software updates, revisions, enhancements, and modifications.

In a conventional manner, POS terminal 20 may be positioned at an in-store location on the premises of the refueling environment and possibly manned by an attendant.

POS terminal 20 is preferably provided in a conventional configuration adapted to include the appropriate software routines, drivers and programs that are executable to perform the various transaction management functions according to the present invention. This software implementation can be readily practiced by those skilled in the art. POS terminal 20 will likewise be configured to ensure appropriate communications with fuel dispenser 14 (in a known manner).

In a typical POS operation, the refueling customer located at the dispenser position makes a payment selection in the usual manner to indicate that cash payment will be tendered after completion of the refueling operation. In particular, the customer selects the “Pay Cash Inside” payment option key to indicate that a cash payment will be made at the POS terminal following the refueling activity. This refueling request (i.e., the cash payment selection) is communicated to POS terminal 20 for further processing.

POS terminal 20 directs activations of the dispensing equipment so that refueling can take place at the initiative of the customer. Suitable commands will be provided to dispenser 14 from POS terminal 20 to facilitate this control instruction. The transaction approval may take the form of a display message that informs the customer that the transaction has been approved and that dispensing can commence.

Although POS facility 20 preferably adopts a conventional point-of-sale architecture (which is suitably modified to cooperate with surveillance system 16), this implementation is shown for illustrative purposes only and should not be considered in limitation of the invention. Rather, it should be understood that POS facility 20 is merely representative of any facility suitable for interacting with surveillance system 16, particularly in regard to executing the control functions of system 16.

Referring more specifically to FIG. 1, the illustrated surveillance system 16 includes a video camera 22 in combination with a video recorder 24. System 16 is suitably installed to enable camera 22 to capture images of the refueling customer and/or the customer vehicle. The captured images are stored on recorder 24. For this purpose, system 16 is disposed at dispenser position 14 or in some other suitable relationship to dispenser position 14 that enables a sufficient line of sight to the customer and/or customer vehicle.

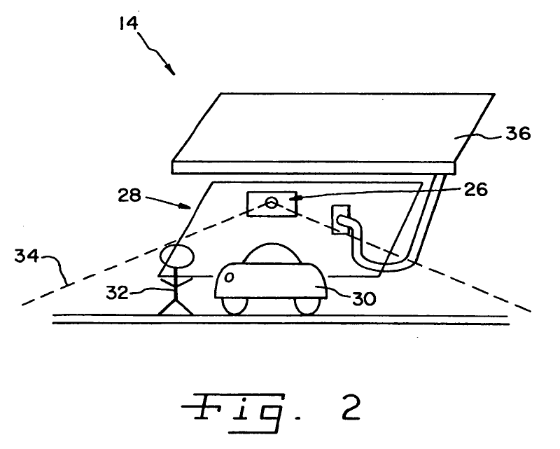

Referring briefly to FIG. 2, there is shown an illustrative schematic pictorial view of one possible arrangement for surveillance system 16 at dispenser position 14. As shown, a security module 26 embodying surveillance system 16 is installed on the front side of dispenser terminal 28 facing the direction in which a vehicle 30 positioned for refueling and a customer 32 will be located during the transaction session.

The video camera 22 located within security module 26 will have an image collection zone or field of view illustratively depicted by coverage pattern 34. As indicated, pattern 34 will encompass the locations pertaining to customer 32 and vehicle 30 so that images of these objects may be acquired.

Although the installation of security module 26 is shown as part of terminal 28, other suitable arrangements are possible. For example, security module 26 may be attached to the canopy or overhead structure 36 that forms a roof-type configuration over terminal 28. Alternately, security module 26 may be located on a tower or other suitable support structure located within or proximate dispenser position 14.

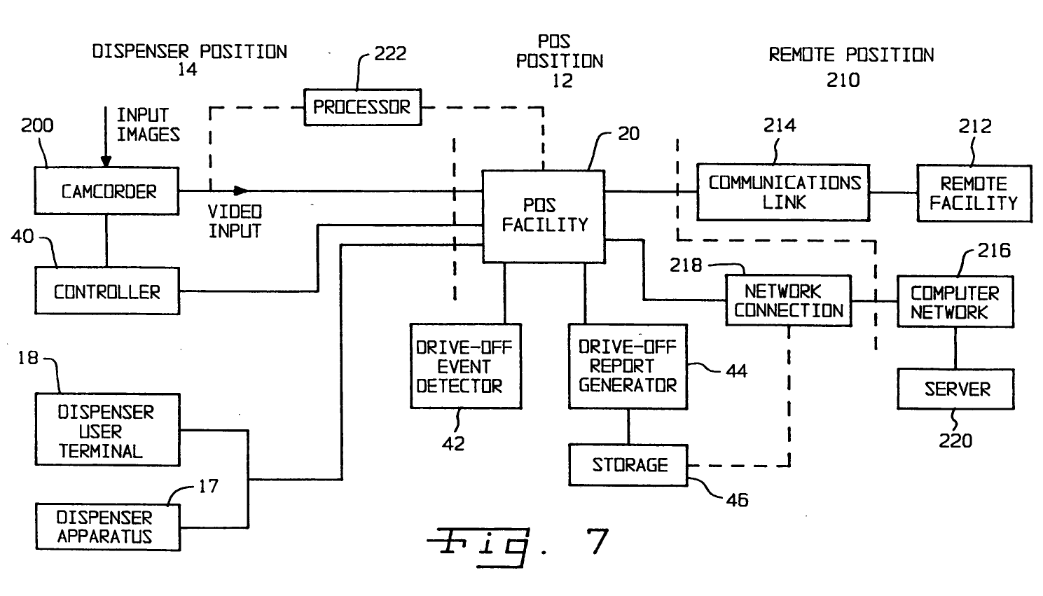

Returning to FIG. 1, camera 22 and recorder 24 may be provided in a conventional construction or any other suitable form. For example, surveillance system 16 can be implemented as a camcorder (FIG. 7). The implementation preferably allows the image collection process and image recordation process to be selectively controlled.

Various other configurations are possible for surveillance system 16. For example, camera 22 and recorder 24 can be provided as an integral unit such as a camcorder. Alternately, these components can be provided as distinct devices arranged in cooperative relationship with one another. In one arrangement, camera 22 can be installed at dispenser position 14, while recorder 24 can be installed at any other location. For example, recorder 24 can be installed at another point in the refueling environment (e.g., POS facility 20) or at a remote site. Any suitable communication link known to those skilled in the art can be used to connect camera 22 and recorder 24, if located apart from one another. Of course, camera 22 and recorder 24 can be co-located as a modular unit.

Recorder 24 should be understood as encompassing any device, medium, and/or process suitable to store and otherwise archive video images. In a preferred form, recorder 24 will have a control feature enabling the selective retrieval of recorded image signals and the execution of other image-related manipulations and operations known to those skilled in the art.

Camera 22 should be understood as encompassing any device, medium, and/or process suitable to collect and otherwise acquire video images. Camera 22 may collect signals in forms that include, but are not limited to, a still image, a series of images, a moving image, a full-motion video sequence, or a combination thereof.

Camera 22 and recorder 24 will preferably include a digital signal processing capability enabling the encoding and storage of collected image signals in digital format. Additionally, these components will be programmable to enable selective control of their respective functions.

In one alternate form, surveillance system 16 is provided with a remote-controlled repositioning mechanism enabling camera 22 to be maneuvered if necessary to bring vehicle 30 and/or customer 32 into view. Conventional apparatus may be used to conduct this camera manipulation, such as a motor-driven actuator assembly, a controller, and a monitoring device to enable an operator to remotely view and control the repositioning activity. A standard robotic assembly may be adapted to this task as well.

Referring again to FIG. 1, the illustrated surveillance system 16 is provided in combination with a controller 40 that issues control commands to camera 22 and/or recorder 24, depending upon the particular functional task that is transpiring. Any suitable implementation can be used for controller 40.

For example, in a camcorder arrangement, controller 40 may be provided in the form of control circuitry forming part of the integrated circuit (IC) on the camcorder microprocessor card. Alternately, controller 40 can be a separate control circuit coupled to surveillance system 16. Additionally, controller 40 can form part of POS 20, in which case the appropriate data and control line connections are established with surveillance system 16.

The illustrated POS facility 20 is integrated with a drive-off event detector 42, a drive-off report generator 44, and a storage unit 46. As discussed in more detail below, detector 42 detects the occurrence of a non-payment drive-off event associated with the current refueling transaction session. Report generator 44 produces a record of a detected drive-off event using a video clip (i.e., video portion or segment) retrieved from surveillance system 16, namely, video recorder 24. Storage 46 can optionally store the generated drive-off record.

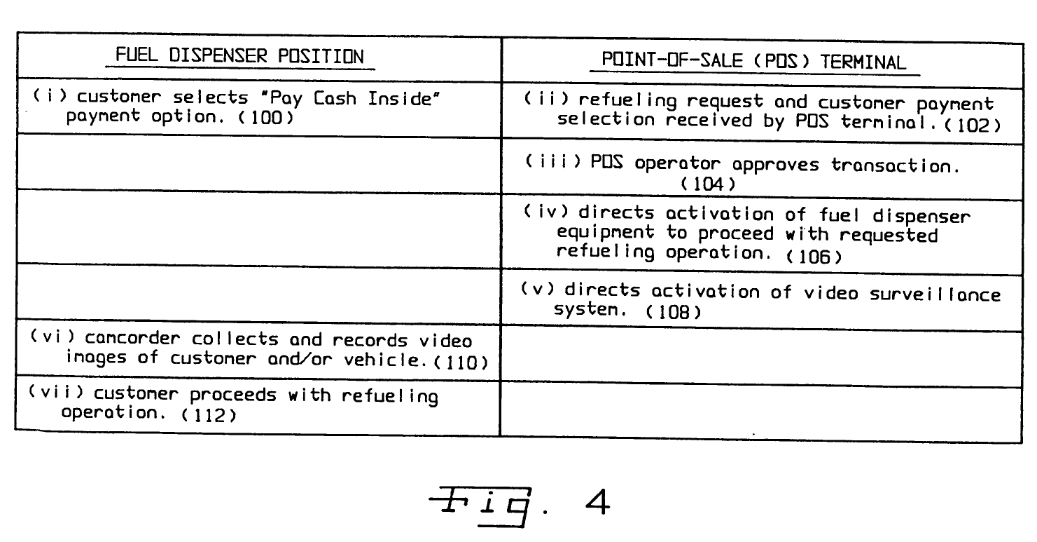

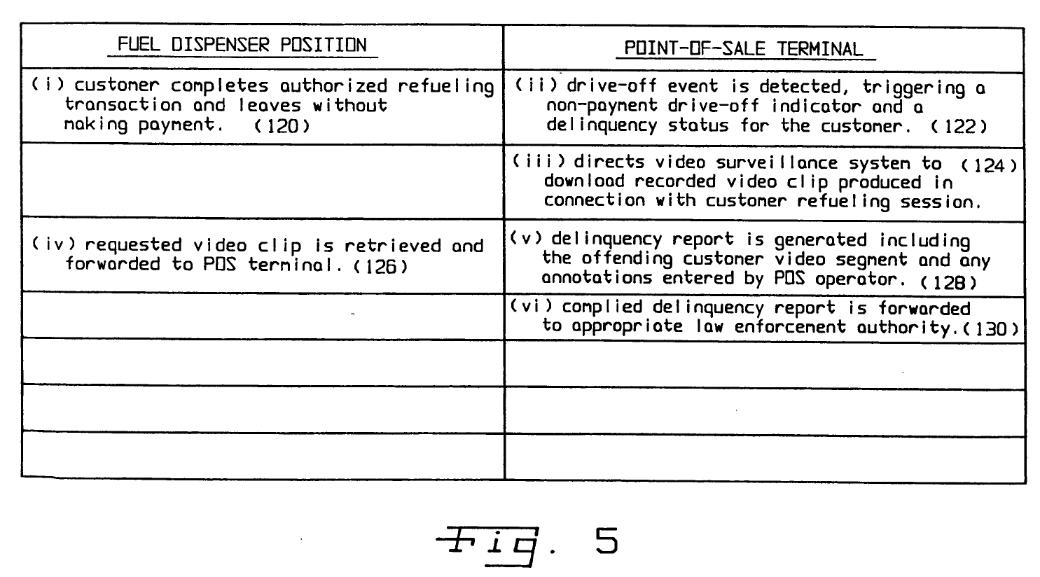

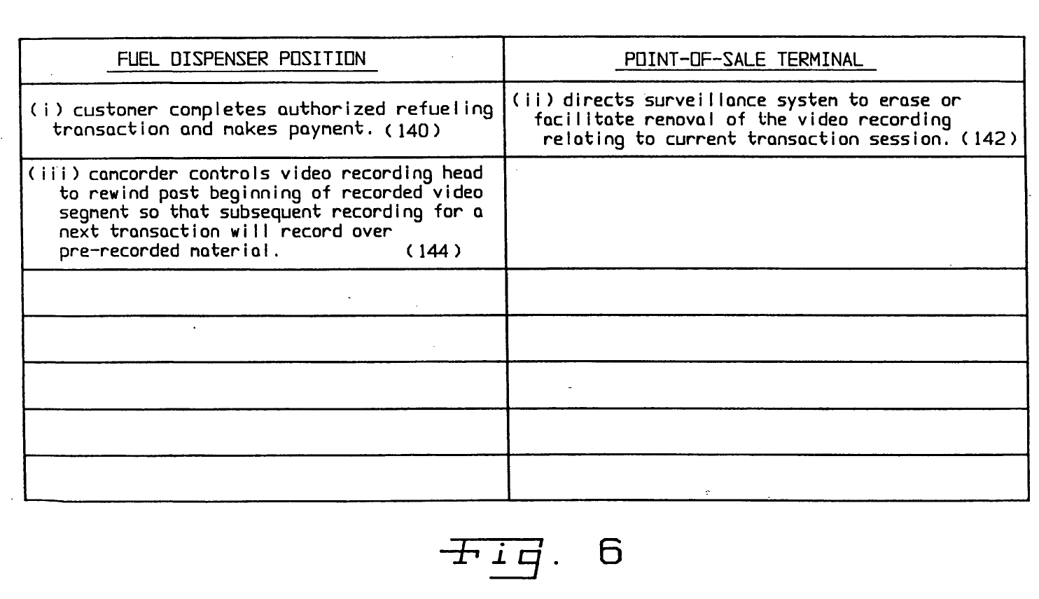

Reference is now made to the operating protocols set forth in FIGS. 4-6 to describe the operation of surveillance system 16 in FIG. 1. More particularly, FIG. 4 describes the protocol associated with managing the surveillance system in conjunction with a refueling transaction request. FIG. 5 describes the protocol associated with detecting and generating a record of a non-payment drive-off event. FIG. 6 describes the protocol associated with managing the surveillance system when the customer tenders full payment for a completed transaction.

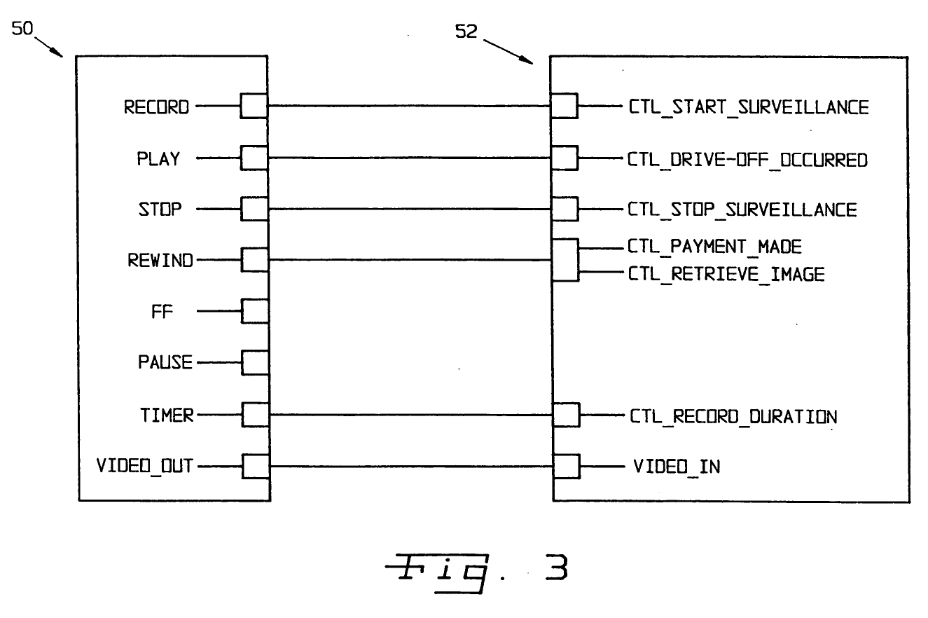

Before proceeding, reference is first made to FIG. 3 to illustrate the functional relationship between the control interface mechanisms associated with surveillance system 16 and the operator side (i.e., POS facility 20). The following discussion pertaining to FIGS. 4-6 will reference both FIGS. 1 and 3.

Referring to FIG. 3, there are shown schematic functional representations of interface circuit or layout 50 associated with surveillance system 16 and interface circuit 52 associated with POS facility 20. For example, interface circuit 50 may form part of controller 40. The indicated connections between interface circuits 50 and 52 illustrate in representative fashion the nature of the control commands that are issued to surveillance system 16 and the corresponding functions that are activated or otherwise controlled. It should be apparent, however, that any suitable control mechanism can be used to establish the necessary control features.

The following description enumerates the various control signals and their corresponding functions in surveillance system 16.

(1) CTL_START_SURVEILLANCE: a control signal that initiates the surveillance activity by activating the video RECORD function of camera 22.

(2) CTL_DRIVE-OFF_OCCURRED: a control signal that requests retrieval of a video segment stored on recorder 24 by activating the PLAY function of recorder 24. This control signal is used in conjunction with the REWIND function. The retrieved video portion is communicated from the VIDEO OUT port on recorder 24.

(3) CTL_STOP_SURVEILLANCE: a control signal that directs the surveillance activity to terminate by ceasing the image collection activity of camera 22. This control signal activates the STOP function of camera 22. In this manner, the station operator can selectively determine the length of the surveillance operation by controlling how long camera 22 is capturing video images.

(4) CTL_PAYMENT_MADE: a control signal that is issued when the station operator receives full payment for a completed transaction. This control signal activates the REWIND function of recorder 24 in a manner which facilitates the removal of the recorded video segment by ensuring that it will be recorded over in its entirety during a subsequent transaction recording. This activity occurs when no drive-off event has been detected (FIG. 6 protocol).

(5) CTL_RETRIEVE_IMAGE: a control signal that is issued when a drive-off event has been detected and the station operator desires to generate a delinquency report including a video segment capturing an image(s) of the customer and/or vehicle (FIG. 5 flowchart). This control signal activates the REWIND function of recorder 24 so that a subsequent activation of the PLAY function will cause the requested video segment to be retrieved and forwarded to POS 20 via the VIDEO_OUT port.

(6) CTL_RECORD_DURATION: a control signal that directs camera 22 to capture images for only a predetermined period of time. This control signal takes advantage of a programmable automated timing feature associated with the image collection process of camera 22. This control signal activates the TIMER function of camera 22.

(7) VIDEO_IN: a communications port that receives video signals transmitted from the VIDEO_OUT communications port of recorder 24.

Reference is now made to FIG. 4 for a discussion of the operation of surveillance system 16. For purposes of discussion, and not in limitation of the present invention, surveillance system 16 is configured as a camcorder.

Initially, a customer drives up to fuel dispenser 14 and suitably positions the vehicle for refueling. In a conventional fashion, the customer interacts with the user interface provided with fuel dispenser 12 and selects a post-payment option. (Step 100). For example, the customer would depress the “Pay Cash Inside” key on the dispenser keypad terminal to indicate that the customer will make a cash payment at the site operator terminal (e.g., convenience store register) following completion of the by refueling operation.

This payment selection and the accompanying refueling request are forwarded from fuel dispenser 14 to POS facility 20 in a conventional manner. (Step 102). In response, POS facility 20 authorizes the transaction and then directs dispenser 14 to permit the requested refueling operation. (Steps 104 and 106). For example, the fuel dispensing equipment would be activated/enabled. The refueling transaction would then proceed in the normal manner.

At the same time, following approval of the transaction, POS facility 20 directs activation of surveillance system 16. (Step 108). In particular, POS facility 20 issues a CTL_START_SURVEILLANCE command (FIG. 3) that effectuates activation of camera 22. In simplified form, this command activates the RECORD function of a camcorder, for example. This command may be accompanied by a timing command (i.e., CTL_RECORD_DURATION) that instructs camera 22 to record for only a certain period of time.

In response, the camcorder collects video images of the customer and/or vehicle and records the captured images. (Step 110). This activity occurs as the customer otherwise proceeds with accomplishing the refueling operation. (Step 112). At this point, once the refueling operation is completed, it is of course expected that the customer will enter the POS facility 20 and make the promised payment.

Reference is now made to the operating protocol set forth in FIG. 5, which describes the sequence for monitoring, detecting, and recording a non-payment drive-off event that occurs after a post-payment refueling operation has been authorized and completed.

The customer completes the approved refueling operation; however, in a scenario commonly referred to as a drive-off event, the customer leaves without making the promised payment. (Step 120). The occurrence of this non-payment drive-off event is detected, such as by POS facility 20. (Step 122).

For this purpose, POS facility 20 may be equipped with some type of monitoring or supervisory facility (i.e., detector 42 in FIG. 1) that automatically triggers an alarm signal indicating the detection of a drive-off event when certain conditions occur. For example, the expiration of a payment timer-could signal that a drive-off event has actually occurred, requiring visual confirmation by an operator.

The timer could be set upon receiving a start signal indicating that POS facility 20 has-authorized the transaction. Alternately, the timer could be set upon receiving a signal from dispenser 14 indicating that refueling has either begun or ended. In either case, the timer would be programmed to give the customer a certain fixed time for making payment. The timer would not generate an alarm signal provided that it received a signal (e.g., from the POS terminal or payment register) indicating that actual payment was made.

It should be apparent that the detection of a drive-off event may be made in any suitable manner, encompassing automated detectors, manual detection, or a combination thereof. For example, the video surveillance camera could detect movement of the customer vehicle and report this development to POS facility 20. If payment has not yet been received, it may be considered that a drive-off event has occurred.

Additionally, the site operator (e.g., store attendant) can visually perceive that the customer has driven off without paying. The attendant can then report this to POS facility 20 by actuating a drive-off event signaling key, for example, or by any other suitable means.

Once POS facility 20 has an indication that a drive-off event has occurred, POS facility 20 enters an operating mode in which it will retrieve the video segment pertaining to the drive-off customer and compile a delinquency report including the video segment. In particular, through a series of suitable control commands directed to surveillance system 16 via controller 40, POS facility 20 will direct the camcorder to download the current recorded video segment. (Step 124). For example, appropriate activation of the REWIND and PLAY functions on the camcorder will effectuate the desired downloading.

In response, the camcorder will furnish the requested video portion to POS facility 20. (Step 126). POS facility 20 will then use report generator 44 to produce a report or other such record of this drive-off event. (Step 128). Generator 44 may be any suitable system allowing the creation of a document or other such medium that can contain video images. A software-based document editor can also be used to add comments to the video production as a separate but associated file. Alternately, the retrieved video segment can simply be transferred to a videocassette. Moreover, in internet applications, the drive-off record can take the form of one or more web pages using an HTML editor. In this manner, the drive-off record can be uploaded to a network server.

The drive-off record will preferably include details of the drive-off refueling operation and any other information deemed pertinent by the operator. In particular, the record would include the amount and price of dispensed fuel, date/time of offense, location of station, and any pertinent business contact information.

At this point, the completed drive-off record could be stored off-line for later submission to the appropriate law dish enforcement authority or automatically transmitted to a police station over a dedicated alarm line to facilitate rapid apprehension of the fleeing customer. (Step 130).

Referring now to FIG. 6, this protocol illustrates the operating sequence when no drive-off event is detected. In particular, if the customer tenders payment following completion of the refueling operation, POS facility 20 enters an operating mode in which it directs surveillance system 16 to remove the video recording relating to the as-completed transaction session. (Steps 140 and 142).

In one arrangement, for example, POS facility 20 issues appropriate control commands to the camcorder via controller 40 to instruct the camcorder to rewind past the starting point of the recorded video clip. (Step 144). In this manner, during a subsequent transaction session, the new video images will record over the previous recorded segment.

Any suitable means may be used to indicate to POS facility 20 that customer payment has been tendered. For example, a signal from the in-store payment register may be automatically communicated to POS facility 20. Alternately, the payment recognition function can be readily linked in software to the payment register functions.

Reference is now made to FIG. 7, which shows a block diagram illustration of a surveillance system implemented with a camcorder 200 and configured for network communications, according to another example of the invention.

Camcorder 200 is disposed at fuel dispenser position 14 and arranged for connection to POS facility 20 in any conventional manner. Camcorder 200 may be controlled by controller 40, which may represent the installed control circuitry typically resident with camcorder designs or an external control module.

According to one feature of this example, the refueling environment is configured for communication with remote positions. 210. Remote positions 210 can assume any configuration known to those skilled in the art. For example, POS facility 20 can be connected to a remote facility 212 (such as a remote dispenser management site) using suitable communications link 214, which may have a wireless or wireline configuration.

Alternately, POS facility 20 can be connected to a computer network 216 over a suitable network connection 218. Computer network 216 may be connected to a representative server 220. In one form, computer network 216 includes the Internet and/or World Wide Web (WWW) so that POS facility 20 and server 220 can behave in a client-server relationship. For this purpose, POS facility 20 would be equipped with suitable computer technology, such as a browser.

In order to facilitate a web-based implementation, camcorder 200 would be provided in combination with a suitable processor 222 that processes the video output signal from camcorder 200 and renders it compatible for communication over network connection 218. For example, processor 222 would packetize the video images for transmission according to the TCP/IP communications protocol of the Internet. Processor 222 could be provided separately from camcorder 200 or made an integral part of a self-contained “black box”-type modular unit.

One feature of FIG. 7 is that video images can be transferred over computer network 216 either in real-time or following retrieval from a video archival medium (i.e., storage 46). In this manner, it may be possible to directly transmit captured video images to server 220 without any intermediate storage at the refueling environment. This operating mode would be realized, for example, by activating the PLAY function of camcorder 200 simultaneous with the RECORD function and connecting the video output port of camcorder 200 to network connection 218.

The connectivity with remote positions 210 also enables any delinquency reports generated at the refueling environment to be transferred to various remote locations for further examination and processing.

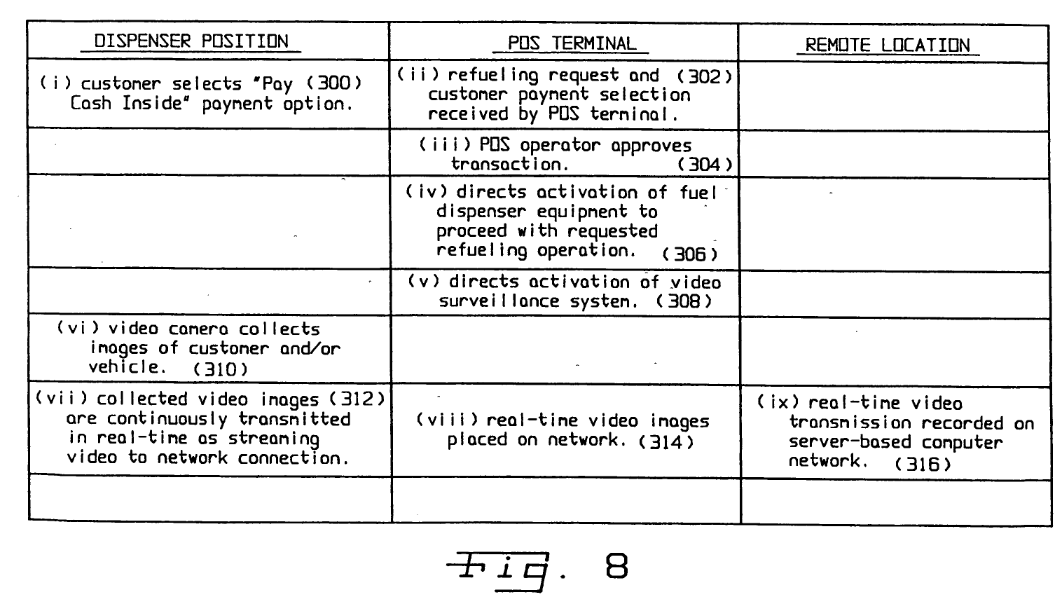

Referring now to FIG. 8, there is set forth an operating protocol describing the sequence of operations pertaining to the surveillance system of FIG. 7. Steps 300-310 correspond to steps 100-110, respectively, in FIG. 4.

While the surveillance activity is pending, the video images collected by camcorder 200 are continuously transmitted in real-time as streaming video to network connection 218. The internet-related communication message containing the video images is suitably formatted according to well-known internet technology to facilitate the appropriate addressing so that the video images reach their intended destination, e.g., server 220. (Steps 312, 314 and 316).

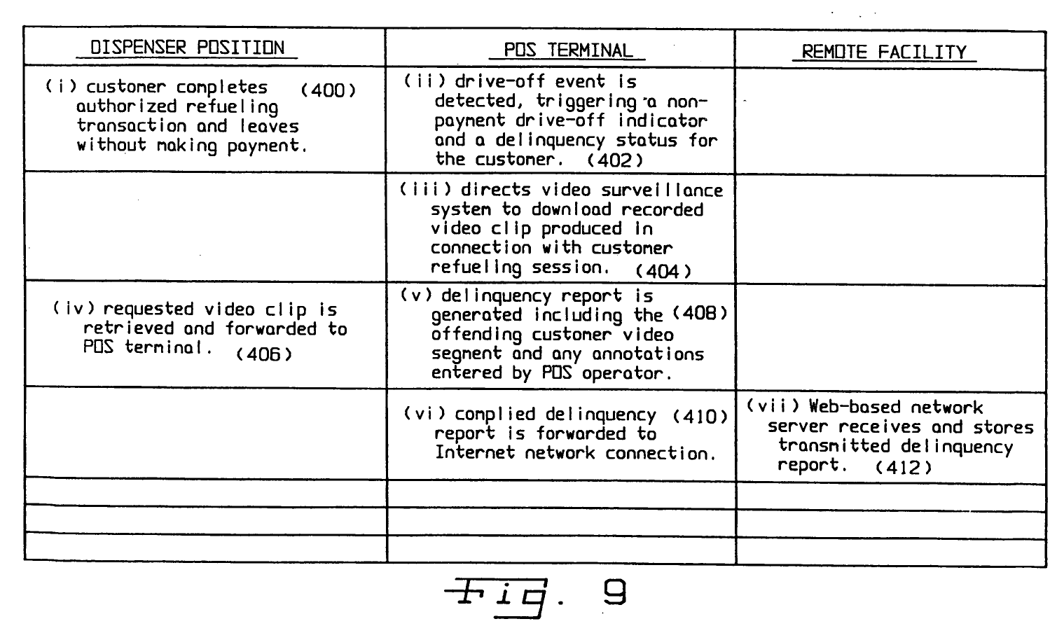

Referring now to FIG. 9, there is set forth an operating protocol describing the sequence of operations pertaining to the surveillance system of FIG. 7, following the occurrence of a non-payment drive-off event. Steps 400-408 correspond to steps 120-128, respectively, in FIG. 5.

Once POS facility 20 receives the relevant video clip from camcorder 200, a delinquency report is generated in a manner similar to that described in connection with FIG. 1. This report is then forwarded to network connection 218 and from there transmitted to server 220 for archival. (Steps 410 and 412).

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system, comprising:
a fuel dispenser position; and
a video camera-recorder combination operatively associated with said fuel dispenser position;
said video camera-recorder combination being configured to acquire and record at least one video signal comprising at least one of a dispenser user image and a user vehicle image.

2. The system as recited in claim 1, wherein said video camera-recorder combination being configured further to operate in response to a signal indicating authorization of a transaction pertaining to the dispenser user.

3. The system as recited in claim 1, wherein said video camera-recorder combination being configured further to operate automatically in response to a signal indicating the presence of a vehicle in association with said fuel dispenser position.

4. The system as recited in claim 1, wherein said video camera-recorder combination includes a camcorder.

5. The system as recited in claim 1, further comprises:
a network connection operatively coupled to said video camera-recorder combination.

6. The system as recited in claim 5, wherein said network connection being configured for connection to at least one of the Internet and World Wide Web.

7. The system as recited in claim 1, wherein said video camera-recorder combination being housed within a fuel dispenser terminal at said fuel dispenser position.

8. The system as recited in claim 1, wherein said video camera-recorder combination being configured further to record over any previously recorded video portions in the absence of a signal indicative of a drive-off event pertaining to the previously recorded video portions.

9. The system as recited in claim 1, wherein said video camera-recorder combination being configured further to provide a still image, a series of images, a moving image, a full-motion video sequence, or a combination thereof.

10. The system as recited in claim 1, further comprises:
a means, responsive to a signal indicative of the occurrence of a non-payment drive-off event, for providing a record of the drive-off event occurrence using at least one video signal operatively recorded by said video camera-recorder combination.

11. A system for use in a refueling environment having a fuel dispenser position, said system comprising:
a surveillance camera operatively associated with said fuel dispenser position, said surveillance camera being configured to operatively collect at least one image pertaining to said fuel dispenser position; and
a controller operatively associated with said surveillance camera, said controller being configured to direct operation of said surveillance camera in response to a signal indicative of a trigger event.

12. The system as recited in claim 11, wherein said surveillance camera being configured further to operatively collect at least one image comprising at least one of a dispenser user image and a user vehicle image.

13. The system as recited in claim 11, wherein said trigger event relating to authorization of a transaction pertaining to a dispenser user.

14. The system as recited in claim 11, further comprises:
a recordation apparatus configured to operatively record images provided by said surveillance camera.

15. The system as recited in claim 14, further comprises:
a means, responsive to a signal indicative of the occurrence of a non-payment drive-off event, for providing a record of the drive-off event occurrence using at least one image operatively recorded by said recordation apparatus.

16. The system as recited in claim 14, wherein said surveillance camera and said recordation apparatus together form a camcorder unit.

17. The system as recited in claim 14, further comprises:
a network connection operatively coupled to said recordation apparatus.

18. The system as recited in claim 17, wherein said network connection being configured for connection to at least one of the Internet and World Wide Web.

19. The system as recited in claim 14, further comprises:
a remote facility disposed apart from said refueling environment;
a communications link between said refueling environment and said remote facility; and
a means to cause recorded images from said recordation apparatus to be operatively communicated to said remote facility over said communications link.

20. The system as recited in claim 11, further comprises:
a remote facility disposed apart from said refueling environment;
a communications link between said refueling environment and said remote facility; and
a means to cause collected images from said surveillance camera to be operatively communicated to said remote facility over said communications link.

21. A system for use in a refueling environment having a fuel dispenser position, said system comprising:
a first means for operatively collecting at least one image relating to said fuel dispenser position;
a second means for operatively recording images collected by said first means; and
a third means for controlling operation of said first means and/or said second means.

22. The system as recited in claim 21, wherein said third means also for activating said first means in response to a signal indicative of a trigger event.

23. The system as recited in claim 22, wherein said trigger event relating to authorization of a transaction pertaining to a dispenser user.

24. The system as recited in claim 22, wherein said trigger event signal issuing from a point-of-sale (POS) facility in said refueling environment.

25. The system as recited in claim 21, wherein said first means and said second means together defining a video camera-recorder combination.

26. The system as recited in claim 21, further comprises:
a fourth means, responsive to a signal indicative of the occurrence of a non-payment drive-off event, for providing a record of the drive-off event occurrence using at least one image recorded by said second means.

27. The system as recited in claim 21, further comprises:
a network; and
a fifth means for causing recorded images from said second means to be placed onto said network.

28. The system as recited in claim 27, wherein said network includes the Internet and/or the World Wide Web.

29. The system as recited in claim 21, wherein said first means also for operatively collecting at least one image relating to a dispenser user and/or a user vehicle.

30. An apparatus for use in a refueling environment having a fuel dispenser position, said apparatus comprising:
a surveillance system including a video camera and a video recording device;
said video camera being disposed proximate said fuel dispenser position;
said video recording device being operatively coupled to said video camera; and
a controller to control said surveillance system.

31. The apparatus as recited in claim 30, wherein said controller being configured to activate said surveillance system in response to a signal indicating approval of a transaction pertaining to a dispenser user.

32. The apparatus as recited in claim 30, further comprises:
a point-of-sale (POS) facility in said refueling environment, said POS facility operatively coupled to said controller.

33. The apparatus as recited in claim 30, wherein said video camera being configured to collect at least one image relating to a dispenser user and/or a user vehicle.

34. The apparatus as recited in claim 30, further comprises:
a network connection operatively coupled to said surveillance system.

35. The apparatus as recited in claim 30, further comprises:
a detector to detect occurrence of a non-payment drive-off event; and
a recordation facility operatively coupled to said detector and said surveillance system.

36. The apparatus as recited in claim 35, wherein said recordation facility being configured to generate a record using recorded images from said video recording device, in response to a signal from said detector indicative of a detected drive-off event.

37. The apparatus as recited in claim 30, further comprises:
a remote facility disposed apart from said refueling environment; and
a communications link between said surveillance system and said remote facility.

38. A method for use in a refueling environment having a fuel dispenser position, said method comprising the steps of:
acquiring at least one image associated with said fuel dispenser position, following the occurrence of a trigger event; and
recording any acquired images.

39. The method as recited in claim 38, wherein said trigger event corresponding to authorization of a transaction pertaining to a dispenser user.

40. The method as recited in claim 38, wherein said image acquisition step further comprises the step of:
acquiring at least one image relating to a dispenser user and/or a user vehicle.

41. The method as recited in claim 38, further comprises the steps of:
determining whether a non-payment drive-off event has occurred in relation to a dispenser user; and
associating a drive-off event occurrence with the recorded images, in response to a determination of the drive-off event occurrence.

42. The method as recited in claim 41, wherein said association step further comprises the step of:
providing a record of the drive-off event occurrence using the recorded images.

43. The method as recited in claim 38, further comprises the steps of:
providing a network; and
communicating the recorded images to and over said network.

44. The method as recited in claim 43, wherein said network includes the Internet and/or World Wide Web.

45. The method as recited in claim 38, wherein said image acquisition step further comprises the steps of:
providing a video camera; and
controlling operation of said video camera, in response to a signal issuing from a point-of-sale (POS) facility in said refueling environment indicating approval of a transaction pertaining to a dispenser user.

46. A method for use in a refueling environment having a fuel dispenser position, said method comprising the steps of:
providing a video camera configured to enable the collection of at least one image associated with said fuel dispenser position; and
operating said video camera, in response to the occurrence of a trigger event.

47. The method as recited in claim 46, further comprises the step of:
recording images collected by said video camera.

48. The method as recited in claim 47, further comprises the steps of:
determining if a non-payment drive-off event has occurred; and
following a determination of the occurrence of a non-payment drive-off event, providing a record of the drive-off event occurrence using at least one recorded image.

49. The method as recited in claim 46, wherein said trigger event corresponding to authorization of a transaction pertaining to a dispenser user.

50. The method as recited in claim 46, wherein said video camera being configured further to enable the collection of at least one image relating to a dispenser user and/or a user vehicle.

51. A method for use in a refueling environment having a fuel dispenser position, said method comprising the steps of:
collecting at least one image relating to a dispenser user and/or a user vehicle, following approval of a transaction pertaining to the dispenser user; and
recording the collected images.

52. The method as recited in claim 51, further comprises the steps of:
determining whether a non-payment drive-off event has occurred in relation to the dispenser user; and
associating a drive-off event occurrence with the recorded images, in response to a determination of the drive-off event occurrence.

53. The method as recited in claim 52, wherein said association step further comprises the step of:
providing a record of the drive-off event occurrence using the recorded images.

54. The method as recited in claim 51, further comprises the steps of:
providing a network; and
communicating the recorded images to and over said network.

55. The method as recited in claim 54, wherein said network includes a packet-based data network.

56. The method as recited in claim 51, wherein said image collection step further comprises the steps of:
providing a video camera; and
controlling operation of said video camera, in response to a signal issuing from a point-of-sale (POS) facility in said refueling environment representing the dispenser user transaction approval.
